(19) United States
(12) Patent Application Publication
(10) Pub. No.: US 2025/0127340 A1
(43) Pub. Date: Apr. 24, 2025

(54) ARTICULATED SHOWER CHAIR, ARTICULATED SHOWERING CHAIR AND SHOWERING WATER MANAGEMENT SYSTEM

(71) Applicant: 12163004 CANADA INC, MONTREAL (CA)

(72) Inventors: Jean-Francois POISSON, MONTREAL (CA); Marc HOFFMAN-ZUKOWSKI, MONTREAL (CA)

(21) Appl. No.: 18/899,079

(22) Filed: Sep. 27, 2024

Related U.S. Application Data
(60) Provisional application No. 63/586,134, filed on Sep. 28, 2023.

(51) Int. Cl. A47K 3/28; A61G 5/00; A61G 5/10; A61G 5/12

(52) U.S. Cl. CPC A47K 3/282; A61G 5/006; A61G 5/1059; A61G 5/1067; A61G 5/127

(57) ABSTRACT

The present articulated shower chair and the present articulated showering chair comprise an articulated shell, a seat, a back and a base. The articulated shell includes a back section and a seat section. The seat section and the back section are mechanically connected to move between a seating position and a reclining position. The back section and the seat section are adapted for directing gray water, the back section directs gray water towards the seat section and the seat section directs gray water to a drain in both the seating position and the reclining position. The seat is adapted to be securely affixed to the seat section of the articulated shell. The back is adapted to be securely affixed to the back section of the articulated shell. The base supports the articulated shell. A showering management system is further provided herewith.

### TECHNICAL FIELD

The present disclosure relates to the field of shower chairs and more particularly to articulating shower chairs and articulated showering chairs.

### BACKGROUND

Showering for the elderly, disabled or individuals with reduced mobility can be a challenge. Solutions currently available include sitting on a stool or a chair to take a shower. Another solution is to roll a special wheelchair in a shower stall to take a shower.

However, the solutions currently available have some serious drawbacks. First, they are not particularly comfortable as the stool, chair and wheelchair are typically made of fixed surfaces which provide very little adjustments. Second, the showering experience using the available solutions often results in having the user intermittently in and out of water and may cause shivers. Thirdly, the current solutions render the task of caregivers difficult and often results in an uncomfortable, damp and noisy work environment with water splashing around the user and on the caregiver, as well as caregiver back pain due to poor posture when handling the user during transfer, during transport, or when providing hygiene care.

There is therefore a need for solutions which alleviates current problems.

### SUMMARY

According to a first aspect, the present articulated shower chair comprises an articulated shell, a seat, a back and a base. The articulated shell includes a back section and a seat section. The seat section and the back section are mechanically connected to move between a seating position and a reclining position. The back section and the seat section are adapted for collecting gray water. The back section directs gray water towards the seat section and the seat section directs gray water to a floor drain in both the seating position and the reclining position. The seat is adapted to be securely affixed to the seat section of the articulated shell. The back is adapted to be securely affixed to the back section of the articulated shell. The base supports the articulated shell.

In a particular aspect, the articulated shell further comprises a knee section, the knee section being mechanically connected to the seat section to move between the seating position and the reclining position, the knee section being adapted for receiving gray water from the seat section and directing gray water to a drain.

In another aspect, the articulated shower chair further comprises a water flow controller and water tubes. The water flow controller is adapted for receiving warm water from a standard temperature-controlled bathroom faucet and reducing the water pressure of the received warm water to a low-pressure. The water flow controller includes a plurality of water pressure regulators. Each water tube is connected to one of the water pressure regulators. The water tubes are positioned along sides of the articulated shell. The water tubes include water outlets disposed along a length thereof. The water tubes are adjustable between a first position where the water outlets project warm water over a user installed on the back and the seat, and a second position where the water outlets project warm water in the articulated shell.

In yet another aspect, sections of the water tubes may be adjustable between the first and the second positions independently.

In another aspect, some sections of the water tubes include multiple series of water outlets.

In a particular aspect, the seat and the back are made of a flexible material.

In yet another aspect, the seat and the back are made of a stretchable material.

In another aspect, the low-pressure is below 5 psi.

In another aspect, the water outlets project water as a series of arched droplets.

In yet another aspect, the water outlets of two of the water tubes include a combination of micro perforations, a first subset of the micro perforations being at a first angle, a second subset of the micro perforations being at a positive angle from the first angle and a third subset of the micro perforations being at a negative angle from the first angle.

In another aspect, two of the water tubes are laterally adjustable along sides of the articulated shell.

In yet another aspect, the articulated shower chair further comprises an atmospheric purge system for gravitationally draining the water from the dispersion tubes and the water flow controller.

In yet another aspect, the present invention provides an articulated showering chair. The articulated showering chair comprises an articulated shell, a seat, a back, a base, a water flow controller, and water tubes. The articulated shell includes a back section and a seat section. The seat section and the back section are mechanically connected to move between a seating position and a reclining position. The back section and seat section are adapted for collecting gray water. The back section directs gray water towards the seat section and the seat section directs gray water to a drain in both the seating position and the reclining position. The seat is adapted to be securely affixed to the seat section of the articulated shell. The back is adapted to be securely affixed to the back section of the articulated shell. The base supporting the articulated shell. The water flow controller receives thermally mitigated warm water at a high pressure and reduces the water pressure to a low-pressure. The water flow controller comprises a plurality of water pressure regulators and water actuators. Each water tube connects to one of the water pressure regulators and one of the water actuators. Some of the water tubes are positioned along edges of the articulated shell. The water tubes positioned along edges of the articulated shell include water outlets disposed along a length thereof. The water tubes positioned along edges of the articulated shell are adjustable between a first position where the water outlets project water over a user installed on the back and the seat, and a second position where the water outlets project water in the articulated shell.

In a particular aspect, the articulated shell further comprises a knee section, the knee section is mechanically connected to the seat section to move between the seating position and the reclining position, the knee section is adapted for collecting and directing gray water to the drain from the seat section.

In another aspect, sections of the water tubes may be adjustable between the first and the second positions independently.

In yet another aspect, some sections of the water tubes include multiple series of water outlets.

In a particular aspect, the seat and the back are made of a flexible material.

In another aspect, the seat and the back are made of a stretchable material.

In another aspect, the low-pressure is below 5 psi.

In yet another aspect, the water outlets project water as a series of arched droplets.

In another aspect, the water outlets of each water tube include a combination of micro perforations, a first subset of the micro perforations being at a first angle, a second subset of the micro perforations being at a positive angle from the first angle and a third subset of the micro perforations being at a negative angle from the first angle.

In yet another aspect, the water tubes are laterally adjustable along sides of the articulated shell.

In another aspect, the articulated showering chair further comprises an atmospheric purge system for gravitationally draining the water from the dispersion tubes and the water flow controller.

In another aspect, a system for a shower chair is provided. The system comprises a water flow controller and water tubes. The water flow controller is adapted for receiving water and reducing the water pressure to a low-pressure. The water tubes are adapted to be connected to the water flow controller. The water tubes are adapted to be positioned along the sides of the shower chair. The water tubes include water outlets disposed along a length thereof. The water tubes are adjustable between a first position where the water outlets project water over a user installed on the shower chair, and a second position where the water outlets project water below the shower chair.

In accordance with a particular aspect of the system, the water flow controller further comprises a plurality of water actuators. Each water actuator has an inlet, an outlet, and an actuator. The inlet is adapted for receiving the low-pressure water. The output is adapted to be connected to the water tubes. Each water actuator allows flow of the low-pressure water from the inlet to the outlet in an open position and the actuator stops the flow of the low-pressure water from the inlet to the outlet in a closed position.

In yet another aspect of the system, the low-pressure is below 5 psi.

In another aspect of the system, the water outlets project water as a series of arched droplets.

In a particular aspect of the system, the water outlets of each water tube include a combination of micro perforations, a first subset of the micro perforations being at a first angle, a second subset of the micro perforations being at a positive angle from the first angle and a third subset of the micro perforations being at a negative angle from the first angle.

In another aspect of the system, the water tubes are laterally adjustable along the sides of the shower chair.

In yet another aspect, the system further comprises an atmospheric drain for gravitationally purging the water from the dispersion tubes and the water flow controller.

### BRIEF DESCRIPTION OF THE DRAWINGS

Embodiments of the disclosure will be described by way of example only with reference to the accompanying drawings, in which:

FIG. 1 is a perspective view of an example of an articulated shower chair in a sitting position with a base.

FIGS. 2A-2C illustrate different views of the articulated shower chair without a base.

FIG. 3 is a simplified functional view of the present showering water management system 200.

FIG. 4 is a simplified flow diagram illustrating the water flow sequence of the showering water management system 200.

FIG. 5 illustrates perspective views and cross-sectional views of an example of microperforated water tubes 235.

FIG. 6 illustrates on the left hand-side the effect of gravity on operation of the microperforated water tube 235, and on the right hand-side operation of the microperforated water tube 235 when pressure restriction is applied between sections of the microperforated water tube 235.

FIG. 7 illustrates multiple shorter microperforated water tubes 235 interconnected by flow restriction adaptors R.

FIG. 8 is a top view of the showering water management system 200 installed in a shower chair occupied by a user.

FIG. 9A is a back perspective view of an embodiment of showering water management system 200.

FIG. 9B is a front perspective view of the showering water management system 200 of FIG. 9A in operation.

FIG. 10A is a back perspective view of an articulated showering chair 400.

FIG. 10B is a top left perspective view of the articulated showering chair 400 without back, seat and knee pad.

FIG. 10C is a top left perspective view of the articulated showering chair without back, seat and knee pad.

FIG. 10D is a top left perspective view of the articulated showering chair 400 of FIG. 10B in operation.

FIG. 10E is a top left perspective view of the articulated showering chair 400 of FIGS. 10B in operation with armrests, back, seat and knee pad.

FIG. 11 is a schematic illustration of components of a shower experience controller.

### DETAILED DESCRIPTION

The foregoing and other features will become more apparent upon reading of the following non-restrictive description of illustrative embodiments thereof, given by way of example only with reference to the accompanying drawings. Like numerals represent like features on the various drawings.

The present invention is directed to shower chairs, and more particularly to an articulated shower chair, an articulated showering chair and a showering water management system for transforming a shower chair into a showering chair. The present articulated shower chair, articulated showering chair and system are designed to bring comfort and provide a very enjoyable showering experience to a user. The present articulated shower chair, articulated showering chair and system are further convenient for providing caregivers assisting users in showering with a quiet and peaceful environment without being splashed by water. In the context of the present description, the word “user” is meant to refer to an autonomous person, a handicap person, or a non-autonomous person.

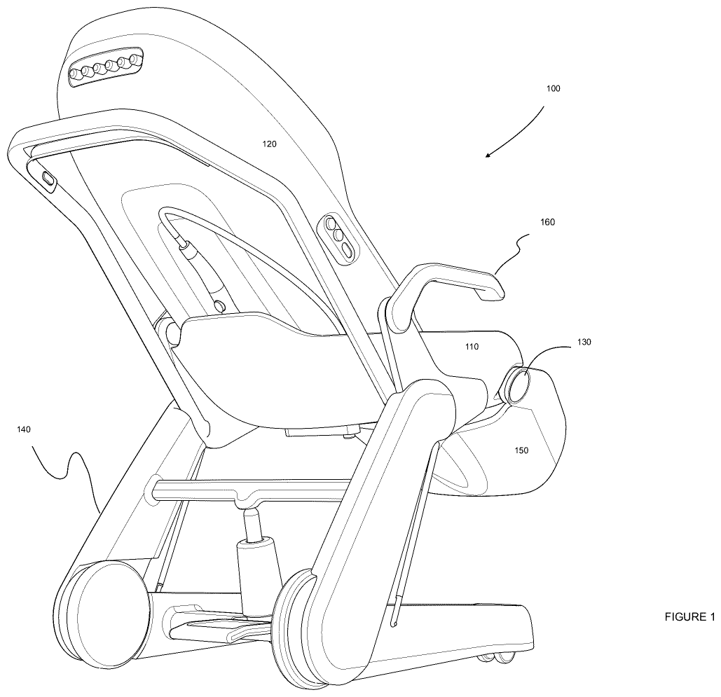

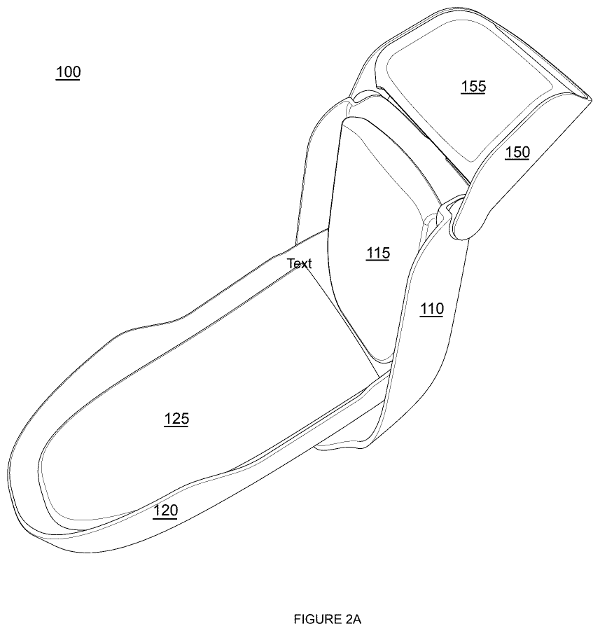

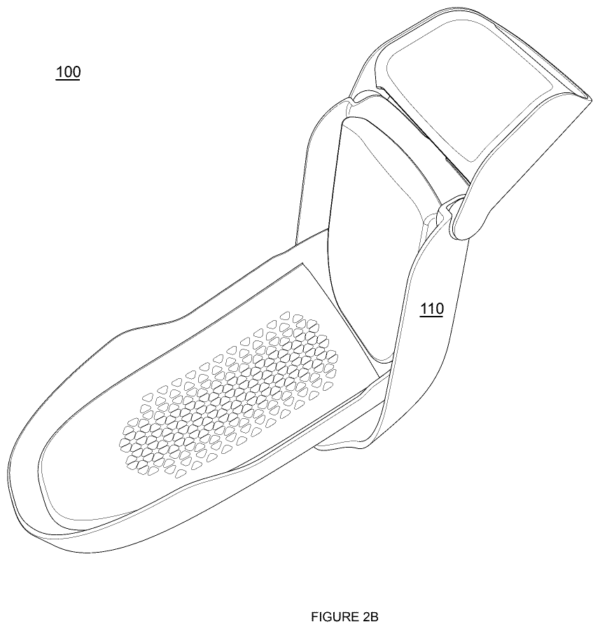

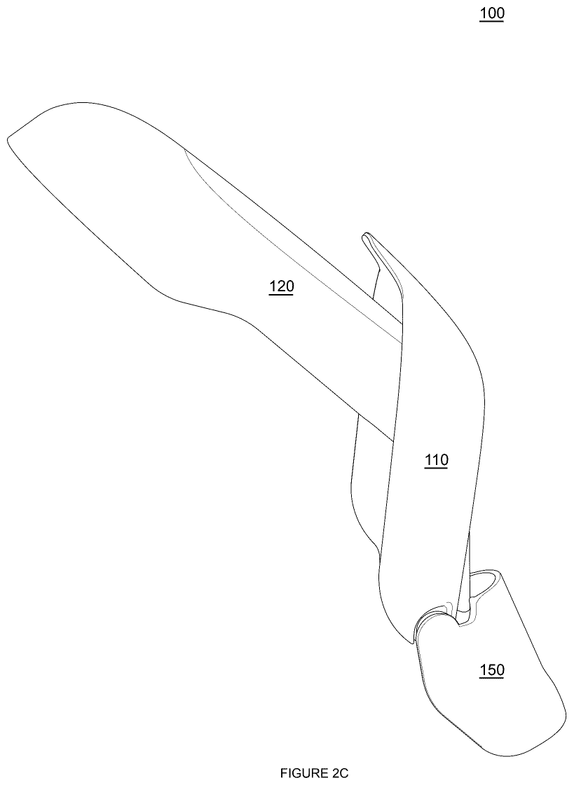

To facilitate understanding, the articulated shower chair and the system for transforming a shower chair into a showering chair are complementary, while the articulated showering chair is a combination of the articulated shower chair and the system for transforming the shower chair into the showering chair. For simplicity purposes, reference is now concurrently made to FIGS. 1-2C. FIGS. 1-2C illustrate examples of an articulated shell. The system for converting a shower chair into a showering chair may be used with the articulated shells or with other types of shower chairs.

### Articulated Shower Chair

The present articulated shower chair comprises an articulated shell 100 (FIGS. 2A-2C). The articulated shell 100 includes a seat section 110 and a back section 120. The seat section 110 and the back section 120 of the articulated shell are mechanically connected and move between a range of positions: seating position, a reclining position as well as a standing position used during some types of user transfers. The seat section 110 and the back section 120 of the articulated shell may for example be joined by articulating mechanical joints 130 as illustrated.

The seat section 110 and the back section 120 of the articulated shell 100 are adapted for receiving and directing gray water. The back section 120 of the articulated shell 100 directs water received therein towards the seat section 110. The seat section 110 of the articulated shell 100 receives water directly and from the back section 120. The seat section 110 of the articulated shell 100 directs gray water received therein towards a drain (not shown). The seat section 110 of the articulated shell 100 may further be shaped to collect a certain amount of gray water when in the reclining position, and excess water is directed towards the drain. The seat section 110 and the back section 120 of the articulated shell are shaped to receive and direct the received gray water towards the drain in both the seating position and the reclining position. For doing so, a portion of the seat section 110 extends below the back section 120 when the articulated shower chair is in the reclining position. Alternatively, a portion of the back section 120 may extend below the seat section 110 when the articulated shower chair is in the sitting position. Any other combination of rigid or soft material overlaps, overhangs, or projections may be used to allow receiving and directing water received by the back section 120 and the seat section 110 of the articulated shell 100 and prevent any water from dripping underneath the articulated shell 100 when water is received and directed towards the drain could be used.

The seat section 110, the back section 120, and the mechanical joints 130 are all adapted for use in wet environments. Furthermore, the seat section 110 and the back section 120 are made of resistant material that is preferably not cold to the touch.

The articulated shower chair further comprises a seat 115 adapted to be securely affixed to the seat section 110 of the articulated shell 100. The seat 115 may be removably affixed to the seat section 110 of the articulated shell 100 to facilitate cleaning of the seat 115 and cleaning of the seat section 110 between uses. The articulated shower chair further comprises a back 125 adapted to be securely affixed to the back section 120 of the articulated shell 100. The back 125 may be removably affixed to the back section 120 of the articulated shell 100 to facilitate cleaning of the back 125 and cleaning of the back section 120 between uses.

Each of the seat 115 and the back 125 may be made as one piece or include a structure covered and/or supporting another material. The seat 115 and the back 125 may include one or multiple rigid surfaces, a rigid structure at least partially covered by fabric, a mesh, one or a plurality of membranes, a semi-flexible or a flexible material or an appropriate material for comfortably and safely supporting a person. The seat 115 and the back 125 are made of materials designed to be in direct contact with skin and adapted to wet conditions.

The articulating mechanical joints 130 may provide one-degree-of-freedom motion or two-degree-of-freedom motion. The articulating mechanical joints 130 allow movement of the back section 120 of the articulated shell 100 with respect to the seat section 110 of the articulated shell 100, between the seating position and the reclining position. Any type of articulating mechanical joint 130 known in the industry, and suitable for use in wet conditions or properly protected or waterproofed for use in wet conditions could be used. The present articulated shower chair could include any number of articulating mechanical joints 130 to provide the transition safely and smoothly between the sitting position and the reclining position when a user is installed in the articulated shower chair. The joints of the articulated shell and additional articulating mechanical joints may also include power motorization and automation on all pivots, mechanical joints and links, making it possible to simultaneously move more than one joint at a time, in the manner of a robotic arm, at a desired joint speed for example.

Additional articulating mechanical joints 130 may further be connected to the seat section 110 or the back section 120 to support armrests 160 as well as a properly adjustable headrest (not shown) such as ones comprising a double pivot type support stem, or any other adjustment type known to the industry. The armrests 160 are movable to facilitate installation and user transfers on the articulated shower chair. The armrests 160 can further be articulated to adjust closer to the seat section 110 and/or the back section 120 or distanced from the seat section 110 and/or the back section 120. Any articulating mechanical joints 130 known in the industry of chairs and seats and adapted to wet conditions could be used. Adjusting the armrests 160 with respect to the position of the seat section 110 and/or the back section 120 offers many advantages to the user of the articulated shower chair 100. First, the articulating mechanical joints 130 allow adjustment of the armrests 160 to comfortably receive users of many sizes. Second, the articulating mechanical joints 130 further allow positioning the armrests 160 to prevent falling of a less autonomous user of the shower chair 100 by a caregiver. Thirdly, the additional articulating mechanical joints 130 allow positioning the armrests 160 to facilitate getting off for less physically capable users: the armrests 160 then become a leverage point against which the user can push to facilitate their lifting up movement from the articulated shower chair 100. Thus, the additional articulating mechanical joints 130 serve multiple purposes while providing safety and comfort.

The articulated shell 100 is adapted for being affixed to a base 140. The base 140 may be vertically adjustable to position the seat section 110 and the back section 120, and consequently the seat 115 affixed to the seat section 110, at a comfortable level from the ground. The base 140 may be composed of legs, a central post or any other type of structure adapted to securely receive the seat section 110. The base 140 may be adjustable height wise to adjust to taller or shorter caregivers and users. The base 140 may further include anti-skid protection (not shown) to prevent skidding of the base 140 in a shower, bathroom, or on any type of slippery surface. The base 140 may also include power motorization and automation on all pivots, mechanical joints, links and wheels, making it possible to simultaneously move more than one joint at a time, in the manner of a robotic arm, such simultaneous movements combining the articulated shell and the base in an automatic manner, comprising joint speed and end-positions presets related to a given desired configuration in space, or to a caregiver height, or to a user preference, for example, or to a combination of all these criteria.

Alternatively, the base 140 may comprise a zero-gravity mechanism as well as a pivot mechanism for supporting the seat section 110 and the back section 120. The zero-gravity mechanism may act concurrently as the articulating mechanical joints 130 between the seat section 110 and the back section 120, while further allowing movement of the seat section 110 and the back section 120 with respect to the ground to provide a zero-gravity reclining position. Zero-gravity mechanisms are well known in the art, and any zero-gravity mechanism suitable for wet applications could be used. The independent pivot mechanism, on the other hand, may be used to tilt the seat section and the back section of the shower chair frontward or backward with respect to the base 140 to facilitate ingress and egress of users, for example, when the chair is in the seating, the reclined, or in the standing positions.

The articulated shell 100 may further comprise a knee section 150, the knee section 150 being mechanically connected to the seat section 110. The knee section 150 moves between the seating position and the reclining position along with the seat section 110. Alternatively, the knee section 150 may be fixed with respect to the seat section 110. The knee section 150 collects the gray water received from the seat section 110 and directs the collected water to the drain, quietly, without splashing the floor surrounding the chair, providing for a safer environment for the caregiver. The knee section 150 may further be adapted for receiving a knee pad 155 adapted for offering more comfort to a user. The knee pad 155 may be fixedly removable from the knee section 150 to facilitate cleaning of an interior surface of the knee section 150.

In a particular embodiment, the seat section 110 may further be provided with a recipient for collecting any type of debris dislodged or collected during use of the articulated shower chair 100. The recipient may further include to filter the debris from the water.

### Showering Water Management System

A shower chair refers to a chair that is adapted to be used in a shower but does not provide any showering functionalities. A showering chair refers to a chair which provides showering functionalities. The present showering water management system 200 easily transforms a shower chair, such as the articulated chair 100 into a showering chair or an articulated showering chair 400.

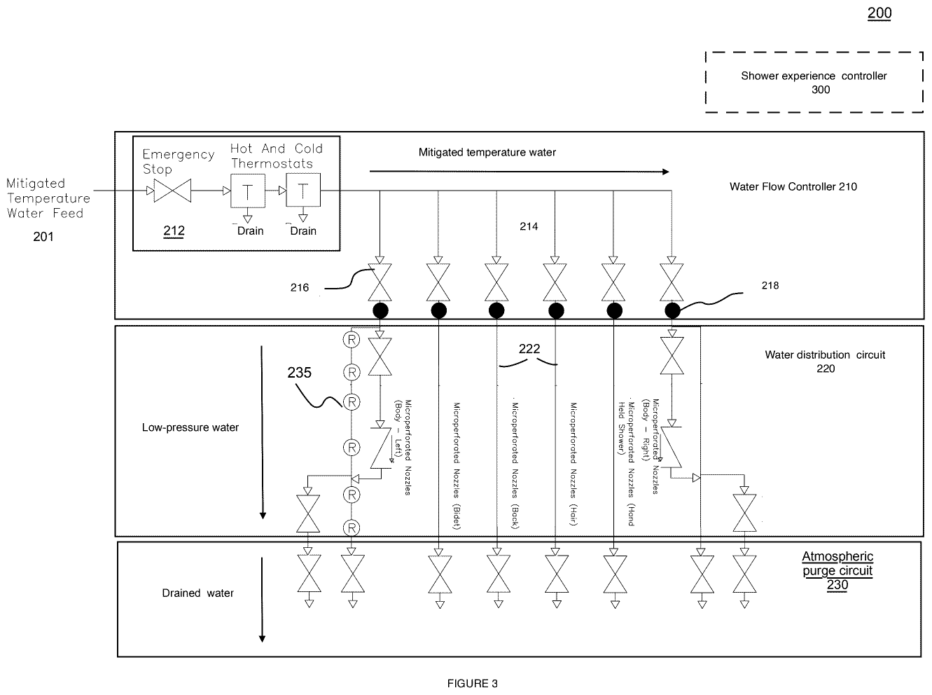

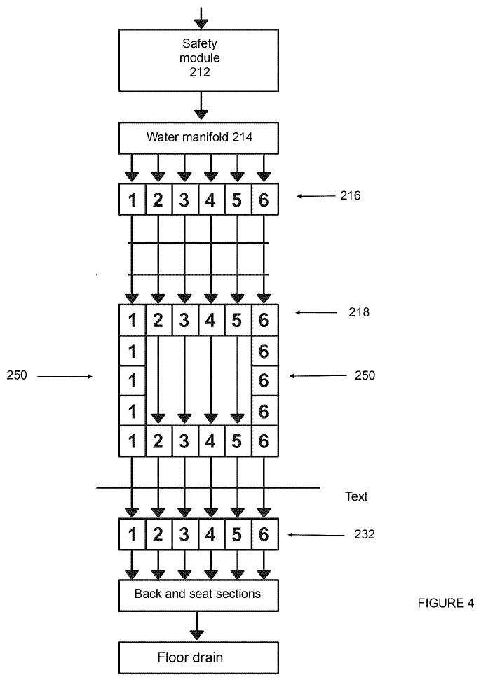

Reference is now concurrently made to FIGS. 3 and 4, where FIG. 3 is a simplified functional view of the present showering water management system 200 and FIG. 4 is a simplified flow diagram illustrating the water flow sequence of the showering water management system 200. The present showering water management system 200 includes a water flow controller 210, a water distribution 220 and an atmospheric purge circuit 230.

The water flow controller 210 may be affixed behind the back of a regular shower chair, behind the back of a wheelchair adapted for showering, or behind the back of the articulated shower chair 100 previously discussed. Alternatively, the water flow controller 210 may be separate from the shower chair but proximate thereto. The water flow controller 210 comprises a mitigated temperature water feed 201, a safety module 212, a water manifold 214, a plurality of pressure-regulating valves 216 and a plurality of actuators 218. The mitigated temperature water feed 201 may be connected by means of a water hose (not shown) to a thermally regulated shower water outlet, for example as those used to connect hand showers. The mitigated temperature water feed 201 is positioned above the water manifold 214, the pressure-regulating valves 216, the actuators 218, the water distribution circuit 220 and the atmospheric purge circuit 230. When connected, the mitigated temperature water feed 201 receives the mitigated temperature water. The mitigated temperature water refers for example to normal residential or institutional water pressure, e.g., be between 20 and 80 psi. Throughout the present description, the expression mitigated temperature water is meant to refer to normal residential or institutional water pressure, and the expression low-pressure water is meant to refer to water pressures below 5 psi.

The mitigated temperature water received by the water flow controller 210 is divided into multiple water channels by the water manifold 214. In the illustrated implementation, the water manifold 214 divides the mitigated temperature water into six water channels. Each water channel starts in the water flow controller 210, continues in the water distribution circuit 220 and terminates in an atmospheric purge circuit 230.

In the water flow controller 210, each water channel is connected to an output of the water manifold 214. Each water channel is then pressure-regulated by one of the pressure-regulating valves 216. The flow of pressure-regulated water for each water channel is controlled by one of the actuators 218.

The present system thus independently controls each water channel. The pressure-regulating valves 216 may be selected or set to output a water flow with predetermined or selected constant water pressure. The pressure-regulating valves 216 may be set to control the pressure of the outputted flow of water to a predetermined water pressure, or some of the pressure-regulating valves 216 may be set to control the pressure of the outputted flow of water to different predetermined water pressures. The water pressure outputted by some of the pressure-regulating valves 216 is below 5 psi. In another particular implementation, the water pressure of the two outermost pressure-regulating valves 216 is set at 2 psi.

Although shown as only one pressure-regulating valve 216 is used for each water channel, the present system is not limited to such an implementation. For example, pressure-regulating may be performed in steps, a preliminary pressure-regulating may be performed in groups for some of the water channels, or any other combination of pressure-regulating concurrently used with the water manifold 214. Any water pressure-regulating valve 216 or combination of water pressure regulators known in the art may be used to regulate the pressure of the outputted water flowing out of the water flow controller 210 into the water distribution circuit 220.

The water flow controller 210 is connected directly or indirectly to the water distribution circuit 220. The water flow controller 210 thus distributes the mitigated temperature water among multiple water channels, regulates the pressure of the flow of water in each water channel, and controls the flow of pressure-regulated water to the water distribution circuit 220. The water flow controller 210 may evenly distribute the mitigated temperature water amongst the plurality of water channels. Alternatively, the water flow controller 210 may distribute the mitigated temperature water amongst the plurality of water channels non-evenly, to provide more water to some of the water channels and less water to some of the water channels. The water flow controller 210 may distribute the mitigated temperature water amongst the water channels statically, dynamically or on demand.

The flow of mitigated temperature water provided by each water channel of the water flow controller 210 is pressure-regulated, at a low-pressure and controlled by the actuators 218. Although shown adjacent to the pressure regulating valves 216, the actuators 218 may be positioned closer to where the mitigated water is to be delivered by the water channel. The actuators 218 allow a user of the showering water management 200 or a caregiver to adjust or modify the distribution of the mitigated temperature water to the various water channels. The actuators 218 combined with the water pressure-regulating valves 216 may allow precise and individual flow and pressure adjustment, modification, actuation, or stopping the distribution of the low-pressure mitigated temperature water in any of the following configuration: left-side and right-side low-pressure water distribution, bottom and middle and top low-pressure water distribution or independent low-pressure water distribution on a per water channel. By adjusting or modifying the distribution of the low-pressure water amongst the plurality of water channels, the pressure of the water amongst the water channels may be varied between 0 and 5 psi.

Each water channel of the water flow controller 210 are connected to one of the water tubes 222 of the water distribution circuit. Many configurations of water tubes 222 may be implemented. In its simplest form, two water tubes 222 are connected to two water channels of the water flow controller 210, where each water tube 222 is affixed adjacent a side of the shower chair 100, for example along sides of the seat 115 in the seat section 110 and on the concurrent sides of the back 125 in the back section 120. In another implementation, four water tubes 222 are connected to four water channels, where one of the water tubes 222 is affixed adjacent a side of the seat 115, another one of the water tube 222 is affixed adjacent another side of the seat, one water tube 222 is affixed adjacent a side of the back 125 and another water tube 222 is affixed adjacent another one side of the back 125. The water tubes 222 are thus affixed alongside the seat 115 and the back 125 in the seat section 110 and the back section 125. In the case of the articulated shower chair 100 previously discussed, the water tubes 222 are longitudinally affixed to the sides of the seat section 110 and the back section 120 of the articulated shell 100 to follow the movement of the seat section 110 and the back section 120 when transitioning between positions.

Each one of the water tubes 222 of the water distribution circuit 220 are ultimately connected to an atmospheric purge circuit 230, and more particularly to a draining valve 232 of the atmospheric purge circuit 230. Although FIG. 3 shows one draining valve 232 per water tube 222, the present showering water management system 200 is not limited to such an implementation. For example, multiple water tubes 222 could be connected to one draining valve 232. When the draining valves 232 are opened, the water tubes 222 are gravitationally purged and the water drained may be directed to a floor drain.

Opening of the draining valves 232 further results in gravitationally purging the water flow controller 210 by activating the actuators 218.

The draining valves 232 may also be opened upon starting the showering water management system 200 to allow a period of warming up the water to be distributed by the showering water management system 200.

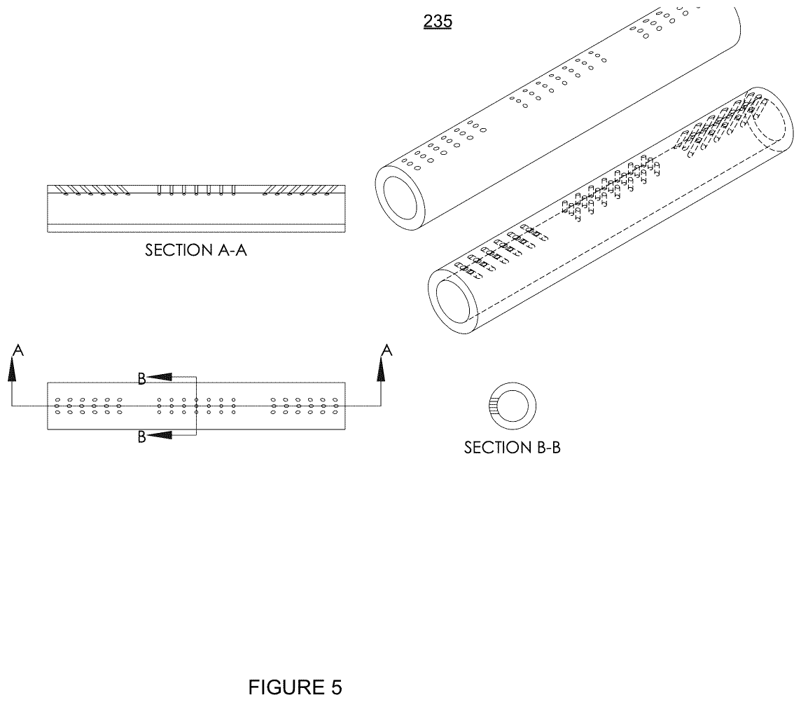

The water distribution circuit 220 includes two types of water tubes: regular water tubes 222 and microperforated water tubes 235. Reference is now further made concurrently to FIG. 5, which illustrates perspective views and cross-sectional views of an example of microperforated water tubes 235. The microperforated water tubes 235 includes one or multiple series of water outlets disposed along at least a section of a length thereof. In a particular implementation, the water outlets of the water tubes 235 are microperforations. Microperforations are commonly used with high-pressure water for misting. However, in the present system, micro perforations are used with low-pressure water to provide very light water flows in the form of thin water columns or sequences of arched droplets, to provide warmth, moisture, and comfort to the user without causing discomfort to the caregiver. The choice of microperforations with a low-pressure water further creates very low noise thus rendering the showering experience more pleasant and less stressful for certain users. The previously described combination of low-pressure water and usage of micro perforations also yields to very low water consumption, hence to very low energy consumption.

The microperforations may for example include a first subset of microperforations at a first angle, a second subset of microperforations at a positive angle from the first angle and a third subset of microperforations at a negative angle from the first angle. Other combinations of microperforations could alternately be used.

The microperforated water tubes 235 may further be rotationally adjustable between a first position where the water outlets are positioned to project water over the user, and a second position where the water outlets are positioned to project water away from the user and a caregiver. To adjust the microperforated water tubes 235 between the first position and the second position, mechanical joints or plumbing unions may be used to connect the microperforated water tubes 235.

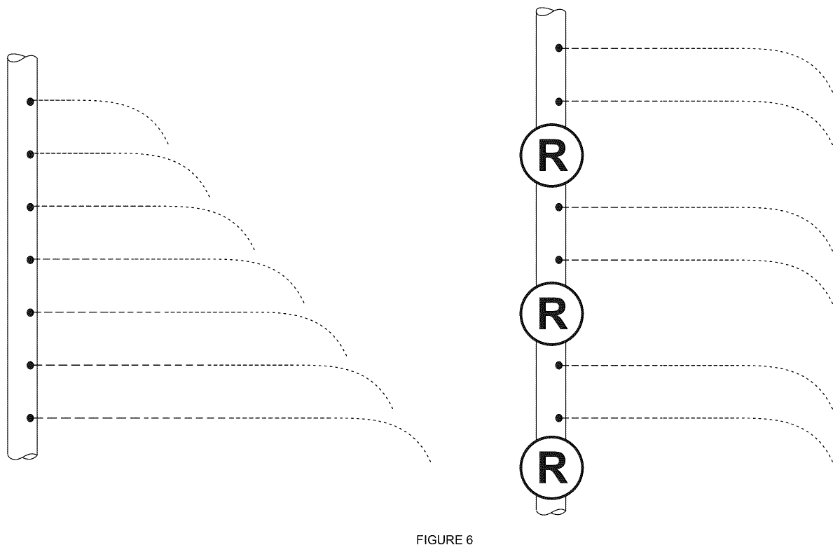

Reference is now further concurrently made to FIG. 6, which illustrates on the left hand-side the effect of gravity on operation of the microperforated water tube 235, and on the right hand-side operation of the microperforated water tube 235 with flow restriction adaptor R interconnecting the smaller sections of microperforated water tubes 235. Gravity related water column weight and inner tube pressure leads to undesirable water column lengths and flow volume variations. For this purpose, flow restriction adapters are integrated into the water tubes to compensate for unwanted pressure variations where differences in water column weight and height may lead to an undesirable pressure differential, typically 1,4 psi per meter of atmospheric elevation.

As the microperforated water tubes 235 are used for distributing a low-pressure water flow along in vertical or angled positions, over a certain length covering the sides of a seat and/or back, the effect of gravity on the water in the microperforated water tubes 235 are displayed on the left-hand side of FIG. 6. To ensure a more evenly distribution of the water flow along a length of the microperforated water tube 235, the microperforated water tube is subdivided into shorter sections of microperforated water tubes, where shorter sections of microperforated water tubes are interconnected by flow restriction adaptor R. Flow restriction adaptors R increase pressure in the microperforated water tube upstream of the flow restriction adaptor R, thereby balancing the flow of low-pressure water along multiple shorter sections of microperforated water tubes 235. In addition to using the flow restriction adaptor R between shorter sections of microperforated water tubes 235, the shorter sections of microperforated water tubes may gradually be reduced in diameter. For example, the implementation on the right-hand side of FIG. 6 illustrates interconnecting four shorter microperforated water tubes 235 of 6 inches in length, with an internal diameter of 8 mm, each shorter section of microperforated water tubes 235 including 36 microperforations of 0.015″ in diameter, for a total of 144 microperforations along the length of the four assembled shorter microperforated water tubes, interconnected by three flow restriction adaptors R. Water flow travels from the top to the bottom of the microperforated water tube 235 assembly. In the implementation illustrated, the flow restriction adaptor R varies in diameter from top to bottom as follows: 0.100″ (top flow restriction adaptor), 0.080″ (middle flow restriction adaptor) and 0.060″ (lower flow restriction adaptor). The operating pressure was 1.5 psi and the water flow was 1.5 liter per minute (lpm).

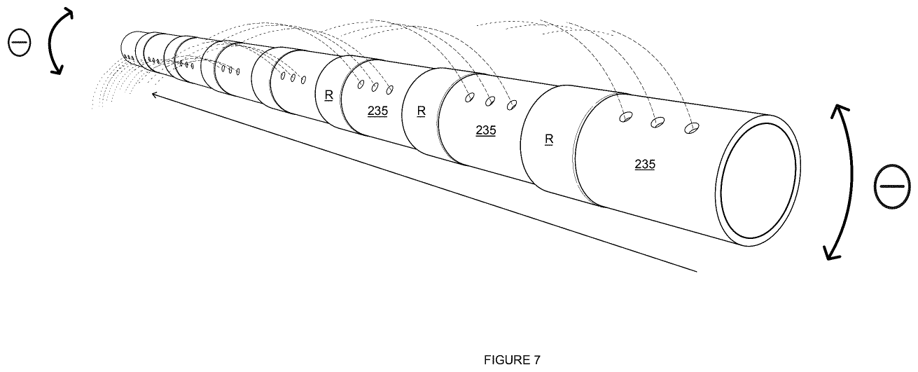

Reference is now further concurrently made to FIG. 7, which illustrates multiple shorter microperforated water tubes 235 interconnected by flow restriction adaptors R. The diameter of the microperforated water tubes 235 gradually decreases along the direction of the water flow. Furthermore, the flow restriction adaptors R are adapted for allowing rotational movement of the shorter microperforated water tubes 235 as shown. The shorter microperforated water tubes 235 may be rotated along an angle ⊖ in a clockwise or counterclockwise direction, independently of one another, to provide optimal flexibility.

The showering water management system 200 may further include a shower experience controller 300, which will be discussed separately later.

The showering water management system 200 further comprises a securing mechanism for affixing and laterally adjusting the water tubes 222 and 235 onto the seat 110 and back 120 of the articulated shell 110. The securing mechanism may further affix and laterally adjust some sections of the water tubes 235 to the back section 120 of the articulated shell 100. The securing mechanism may use any mechanical connector suitable for wet environments.

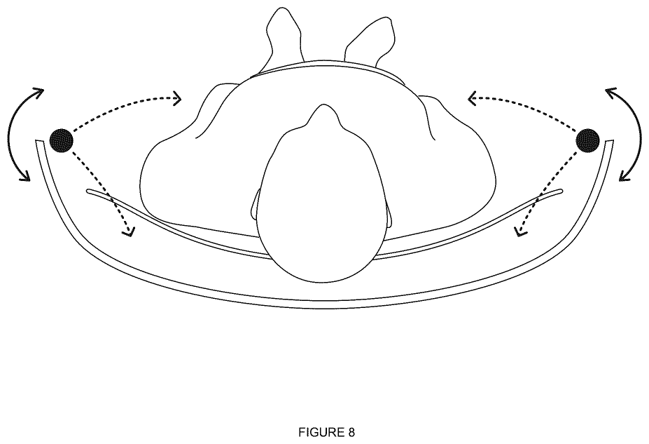

Reference is now further concurrently made to FIG. 8, which is a top view of the showering water management system 200 installed in a shower chair occupied by a user, where the microperforated water tubes 235 can be moved between a showering position and a non-showering position as illustrated by the water flows.

### Articulated Showering Chair

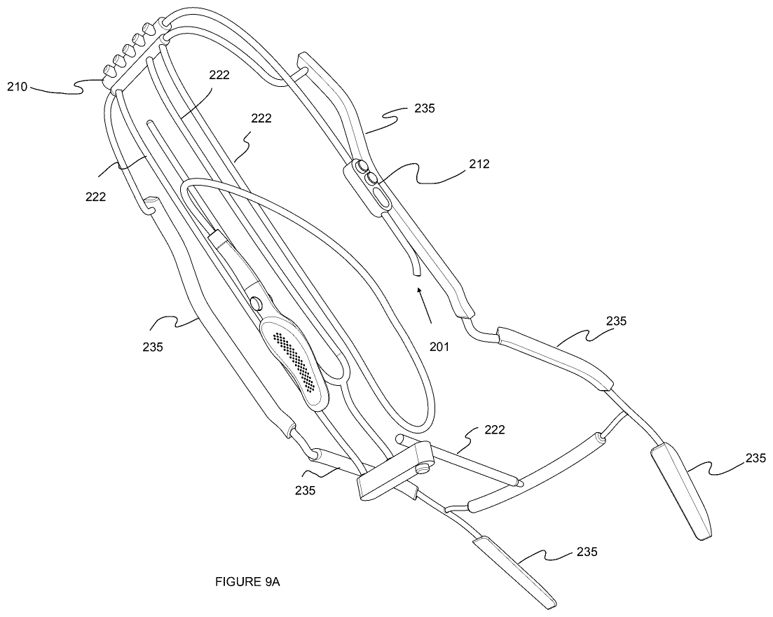

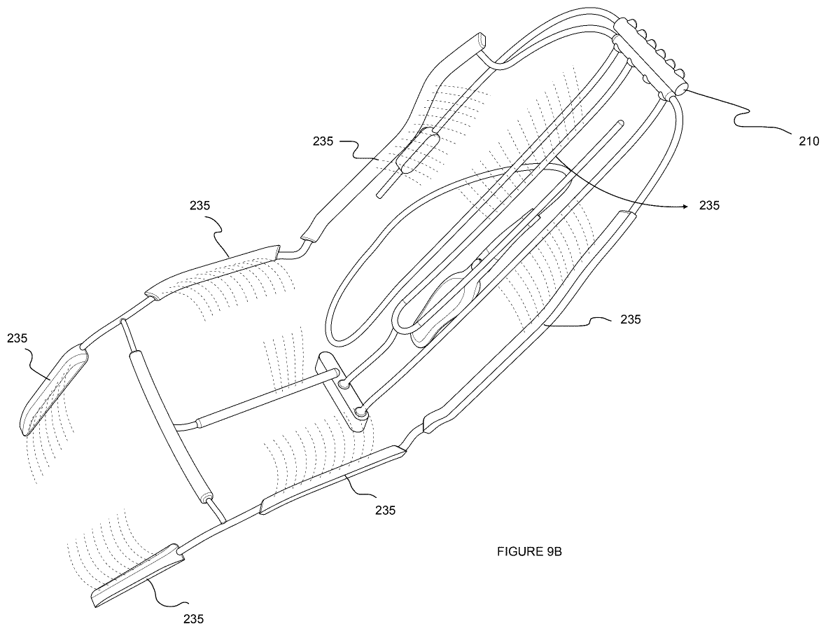

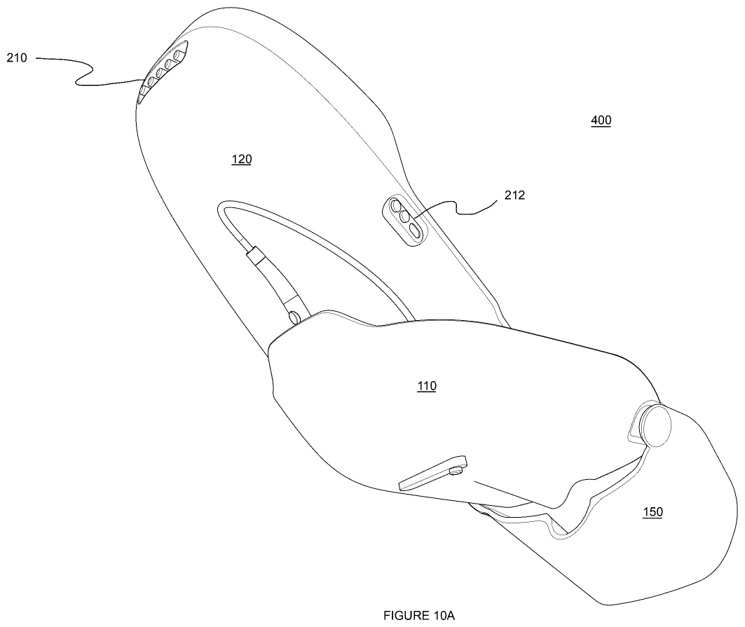

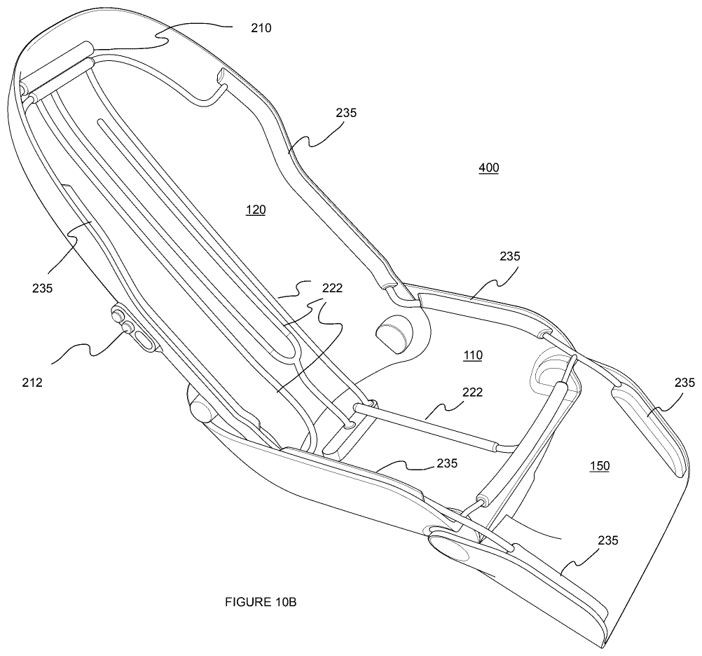

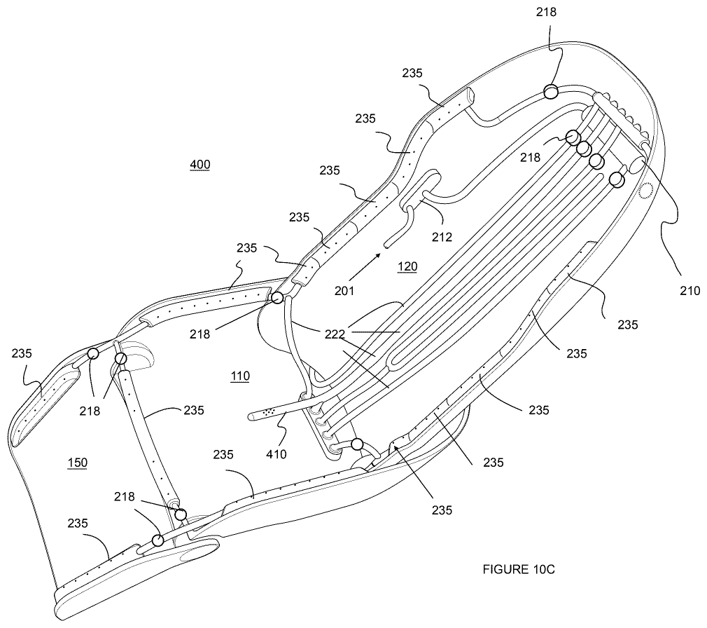

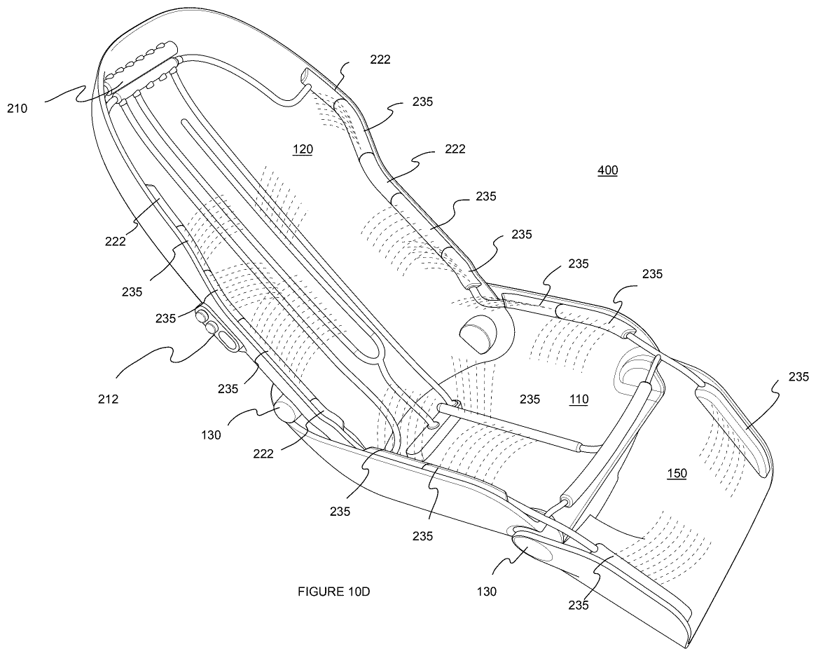

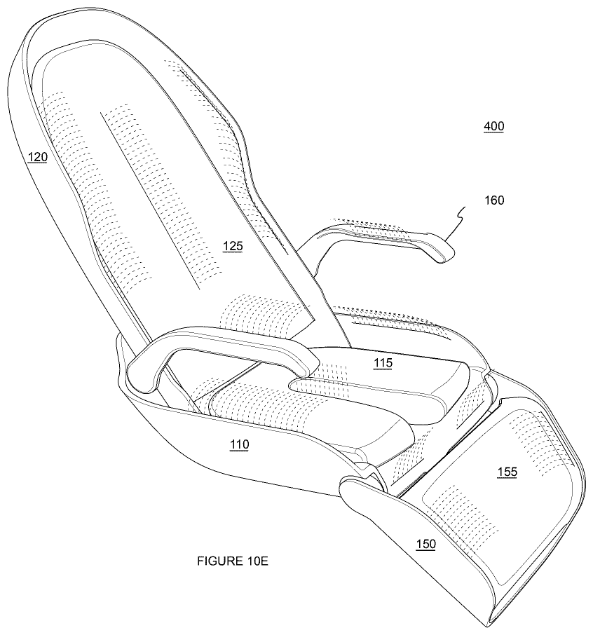

In another aspect, there is provided an articulated showering chair 400. The articulated showering chair 400 is a combination of the previously described articulated chair 100 with the previously described showering water management system 200. Previously described aspects and variants of the articulated shower chair 100 and showering water management system 200 are hereby included to the present articulated showering chair 400. For illustration purposes, reference is now concurrently made to FIGS. 9A and 9B which are respectively back and front perspective views of an implementation of the showering water management system 200 adapted to be integrated into the articulated shower chair 100, as illustrated in FIGS. 10A-10D. For simplicity purposes, only the particular aspects of the articulated shower chair 400 not previously described in the context of the articulated shower chair 100 and the showering water management system 200 will be described. The articulated showering chair includes the water flow controller 210 and the water tubes 222 and 235. The water tubes 222 are positioned underneath the seat 115 and the back 125. The actuators 218 allow a user of the shower chair 100 or a caregiver to adjust or modify the distribution of the low-pressure water in the plurality of the water tubes 222 and microperforated water tubes 235. The actuators 218 may allow precise and individual adjusting, modifying, actuating, or stopping the distribution of the low-pressure water in the plurality of the low-pressure water outlets 250 in any of the following configuration: left-side and right-side low-pressure water distribution, bottom and middle and top low-pressure water distribution or independent low-pressure water distribution. By adjusting or modifying the distribution of the low-pressure water amongst the water tubes 222 and microperforated water tubes 235, the pressure of the water expelled may be varied between 0 and 5 psi.

In addition to the previously discussed microperforated water tubes 235 along the sides of the back section 120, seat section 110 and knee section 150, the present articulated showering chair 400 further includes another microperforated water tube 235 to spray low pressure water along a back of a user.

Another microperforated water tube 235 may be placed along an edge of the seat section 110 so as to distribute low-pressure water under the legs of a user.

Yet another microperforated water tube 235 may be positioned in an opening of the seat 115 to distribute water in the lower back section of a user.

A bidet nozzle may further be connected and operated by the showering water management system 200.

Those skilled in the art will understand that although not specifically illustrated on FIGS. 9A-9B and 10A-10E, the shorter sections of microperforated water tubes 235 are interconnected by flow restriction adaptors R as previously discussed and shown on FIG. 7. The number of shorter microperforated water tubes 235 and flow restriction adaptors R may vary, depending on the overall length to be covered by the water tube 235, the low-pressure of the water, the geometry of the articulated showering chair, etc.

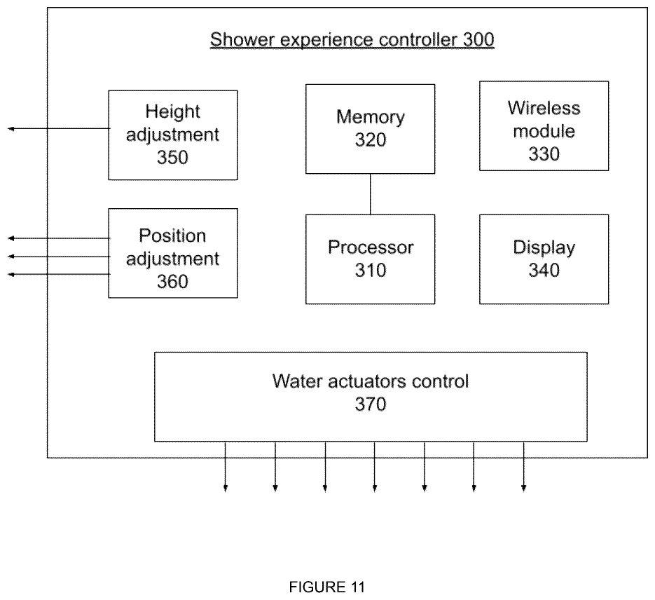

Reference is now further concurrently made to FIG. 11, which is a schematic representation of components of the shower experience controller 300. The shower experience controller 300 comprises a processor 310 and a memory 320. The processor 310 executes a software program and instructions which can automate certain operations of the showering water management system 200 and/or the articulated showering chair 400. The memory 320 is adapted for storing settings, preferences, alerts, etc. Any processor 310 and memory 320, alone or grouped, known in the industry could be used to implement the present shower experience controller 300. The processor 310 may exchange messages, configuration controls and alerts with a mobile application (not shown) or a distinct or remote electronic device through any communication protocols and standards known in the industry, including without limitation Bluetooth, Wi-Fi, LTE, 5G, etc.

The shower experience controller 300 may further include a display 340, for assisting a user or a caregiver in operating the showering water management system 200 and/or the articulated showering chair 400. The display 340 may be a touch-controller display, or a combination of display and buttons, levers, dials, etc.

The shower experience controller 300 further includes a height adjustment module 350. The height adjustment module 350 controls height adjustment of the base 140. The height of the base 140 may be adjusted mechanically, electrically, hydraulically, pneumatically or in combination with thereof. The processor 310 may provide height adjustment preset values, or customization of the height adjustment values based on caregivers preferences, users preferences, type of users, types of transfers required, etc. The processor 310 controls the operation of height adjustment module 140. For example, the height adjustment module 140 may be deactivated when the showering water management system 200 is in operation. The processor 310 may concurrently control operation of the height adjustment module 350 and the position adjustment module 360 to assist with ingress and egress of users.

The position adjustment module 360 controls the operation of the mechanical joints 130 allowing movements between the seat section 110 and the back section 120, and between the seat section 110 and the knee section 150. Movements between the back section 120, the seat section 110 and the knee section 150 to facilitate ingress and egress of users is particularly important to prevent users falling and/or caregiver injuries. The processor 310 ensures smooth and coordinated movements of the mechanical joints 130 and the base 140 height to facilitate transfers of users between for example a hospital bed or a wheelchair.

The processor 310 may further control autonomously or in collaboration with caregivers operating the showering water management system 200 and/or the articulated showering chair 400, operation of various water actuators 218. For example, some water actuators 218 could be manually operated, while other water actuators used in providing the showering experience to users could be automatically controlled by the processor 310. In another embodiment, all water actuators 218 could include both an electronic control provided by the processor 310 and a manual control, such as for example a mechanical override or an electronic override, to allow a caregiver to override the operation of the water actuators 318 performed by the processor 310.

The shower experience controller 300 aims at facilitating operation of the showering water management system 200 and the articulated showering chair 400 for caregivers, while ensuring a pleasant showering experience to users. The shower experience controller 300 further assists in ensuring an even quality of showering experience for users, independent of the caregiver assisting the user.

The shower experience controller 300 further adapts the showering experience to the capabilities of the user, and adapts to users in loss of autonomy. It is thus possible to accompany a user from fully autonomous, through stages of loss of autonomy and complete loss of autonomy with a single articulated showering chair, while ensuring comfortable and pleasant hygiene care in a single environment.

Those skilled in the art will appreciate that as the present articulated showering chair and showering water management system are operated in a wet environment, the articulated showering chair and the showering water management system could be battery-powered to prevent electric shocks.

Although the present disclosure has been described hereinabove by way of non-restrictive, illustrative embodiments thereof, these embodiments may be modified at will within the scope of the appended claims without departing from the spirit and nature of the present disclosure.

What is claimed is:

1. An articulated shower chair, the shower chair comprising:
an articulated shell, the articulated shell including a back section and a seat section, the seat section and the back section being mechanically connected to move between a seating position and a reclining position, the back section and seat section being adapted for collecting water, the back section directing water towards the seat section and the seat section directing water to a drain in both the seating position and the reclining position;
a seat adapted to be securely affixed to the seat section of the articulated shell;
a back adapted to be securely affixed to the back section of the articulated shell; and
a base for supporting the articulated shell.

2. The articulated shower chair of claim 1, wherein:
the articulated shell further comprises a knee section, the knee section being mechanically connected to the seat section to move between the seating position and the reclining position, the knee section being adapted for collecting the directing water to the drain from the seat section.

3. The articulated shower chair of claim 1, further comprising:
a water flow controller for receiving water, reducing the water pressure to a low-pressure and controlling flow of the low-pressure water; and
water tubes connected to the water flow controller, the water tubes being positioned along sides of the articulated shell, the water tubes including water outlets disposed along a length thereof, the water tubes being adjustable between a first position where the water outlets project water over a user installed on the back and the seat, and a second position where the water outlets project water in the articulated shell.

4. The articulated shower chair of claim 3, wherein some sections of the water tubes include multiple series of water outlets.

5. The articulated shower chair of claim 3, wherein the low-pressure is below 5 psi.

6. The articulated shower chair of claim 3, wherein the water outlets project water as a series of arched droplets.

7. The articulated shower chair of claim 1, wherein the water outlets of each water tube include a combination of micro perforations, a first subset of the micro perforations being at a first angle, a second subset of the micro perforations being at a positive angle from the first angle and a third subset of the micro perforations being at a negative angle from the first angle.

8. An articulated showering chair, the articulated showering chair comprising:
an articulated shell, the articulated shell including a back section and a seat section, the seat section and the back section being mechanically connected to move between a seating position and a reclining position, the back section and seat section being adapted for collecting water, the back section directing water towards the seat section and the seat section directing water to a drain in both the seating position and the reclining position;
a seat adapted to be securely affixed to the seat section of the articulated shell;
a back adapted to be securely affixed to the back section of the articulated shell;
a base supporting the articulated shell;
a water flow controller for receiving water and reducing the water pressure to a low-pressure and controlling flow of the low-pressure water; and
water tubes connected to the water flow controller, the water tubes being positioned along edges of the articulated shell, the water tubes including water outlets disposed along a length thereof, the water tubes being adjustable between a first position where the water outlets project water over a user installed on the back and the seat, and a second position where the water outlets project water in the articulated shell.

9. The articulated showering chair of claim 8, wherein:
the articulated shell further comprises a knee section, the knee section being mechanically connected to the seat section to move between the seating position and the reclining position, the knee section being adapted for collecting the directing water to the drain from the seat section.

10. The articulated showering chair of claim 8, wherein sections of the water tubes may be adjustable between the first and the second positions independently.

11. The articulated showering chair of claim 8, wherein some sections of the water tubes include multiple series of water outlets.

12. The articulated showering chair of claim 8, wherein the low-pressure is below 5 psi.

13. The articulated showering chair of claim 8, wherein the water outlets of each water tube include a combination of micro perforations, a first subset of the micro perforations being at a first angle, a second subset of the micro perforations being at a positive angle from the first angle and a third subset of the micro perforations being at a negative angle from the first angle.

14. A showering water management system comprising:
a water flow controller for receiving water, reducing the water pressure to a low-pressure and controlling flow of the low-pressure water;
water tubes connected to the water flow controller, the water tubes being positioned along sides of the shower chair, the water tubes including water outlets disposed along a length thereof, the water tubes being adjustable between a first position where the water outlets project water over a user installed on the shower chair, and a second position where the water outlets project water below the shower chair; and
a securing mechanism for affixing the water tubes onto the shower chair.

15. The system of claim 14, wherein the low-pressure is below 5 psi.

16. The system of claim 14, wherein the water outlets project water as a series of arched droplets.

17. The system of claim 14, wherein the water outlets of each water tube include a combination of micro perforations, a first subset of the micro perforations being at a first angle, a second subset of the micro perforations being at a positive angle from the first angle and a third subset of the micro perforations being at a negative angle from the first angle.

18. The system of claim 14, wherein the water tubes are laterally adjustable along sides of the shower chair.

19. The system of claim 14, further comprising an atmospheric purge for gravitationally purging the water in the dispersion tubes and the water flow controller.
